(19) United States
(12) Patent Application Publication
(10) Pub. No.: US 2014/0179231 A1
(43) Pub. Date: Jun. 26, 2014

(54) SMART VENDING MACHINE

(71) Applicant: Cellco Partnership d/b/a Verizon Wireless, (US)

(72) Inventors: Rahim Charania, Euless, TX (US); Alex Hoyos, Miami, FL (US); Kevin Lim, Danville, CA (US); Ramesh Marimuthu, Edison, NJ (US)

(73) Assignee: CELLCO PARTNERSHIP D/B/A VERIZON WIRELESS, Basking Ridge, NJ (US)

(21) Appl. No.: 13/727,098

(22) Filed: Dec. 26, 2012

(51) Int. Cl. H04W 88/06

(52) U.S. Cl. CPC H04W 88/06
USPC 455/41.2; 455/517

(57) ABSTRACT

A vending machine includes a product dispensing unit and a transceiver configured to communicate via a network. The vending machine further includes a first user interface disposed at a first location on a face of the vending machine and configured to permit users to engage in vending operations so as to cause the dispensing unit to dispense products from the vending machine, and a second user interface disposed at a second location on the face of the vending machine and configured to display information received via the transceiver. The transceiver may include a wireless transceiver and the network may include a cellular network.

### BACKGROUND

Vending machines typically include mechanically and electronically operated devices that automatically dispense various products, such as beverages, snack food items, tickets, consumer products, etc. Vending machines dispense the various products to customers based on the customers supplying payment, in currency or credit form, to the vending machines. Vending machines have been located in many different locations that are expected to generate sufficient sales to justify placing the vending machines in those locations. Those locations include schools, hotels, office buildings, public transportation centers (e.g., train stations, subway stations, automobile rest stops, etc.), truck stops, and shopping centers.

### BRIEF DESCRIPTION OF THE DRAWINGS

FIG. 1 is a diagram that illustrates an overview of a smart vending machine according to exemplary embodiments;

FIG. 2 is a diagram that depicts an exemplary network environment in which multiple smart vending machines of FIG. 1 may operate;

FIG. 3 is a diagram that depicts exemplary components of the smart vending machine of FIG. 1;

FIG. 4 is a diagram that depicts exemplary components of a network device;

FIG. 5 is a flow diagram of an exemplary process for dispensing user-selected products and for presenting advertisements to the user at the smart vending machine of FIG. 1;

FIG. 6 is a messaging diagram associated with the exemplary process of FIG. 5;

FIG. 7 is a flow diagram of an exemplary process for reporting the various maintenance related issues, sensor events, and product inventory and usage associated with the smart vending machine of FIG. 1;

FIG. 8 is a messaging diagram associated with the exemplary process of FIG. 7;

FIG. 9 is a flow diagram of an exemplary process for providing wireless Local Area Network access to one or more of devices associated with respective users of FIG. 1;

FIGS. 10A-10C are diagrams that depict examples associated with the exemplary process of FIG. 9;

FIG. 11 is a flow diagram of an exemplary process for receiving product suggestions for a user using the vending machine of FIG. 1 based on the scanning/reading of a bar code associated with the user;

FIG. 12 is a diagram that depicts a bar code scanning example associated with the exemplary process of FIG. 11; and

FIG. 13 is a messaging diagram associated with the exemplary process of FIG. 12.

### DETAILED DESCRIPTION OF THE PREFERRED EMBODIMENTS

The following detailed description refers to the accompanying drawings. The same reference numbers in different drawings may identify the same or similar elements. The following detailed description does not limit the invention as claimed.

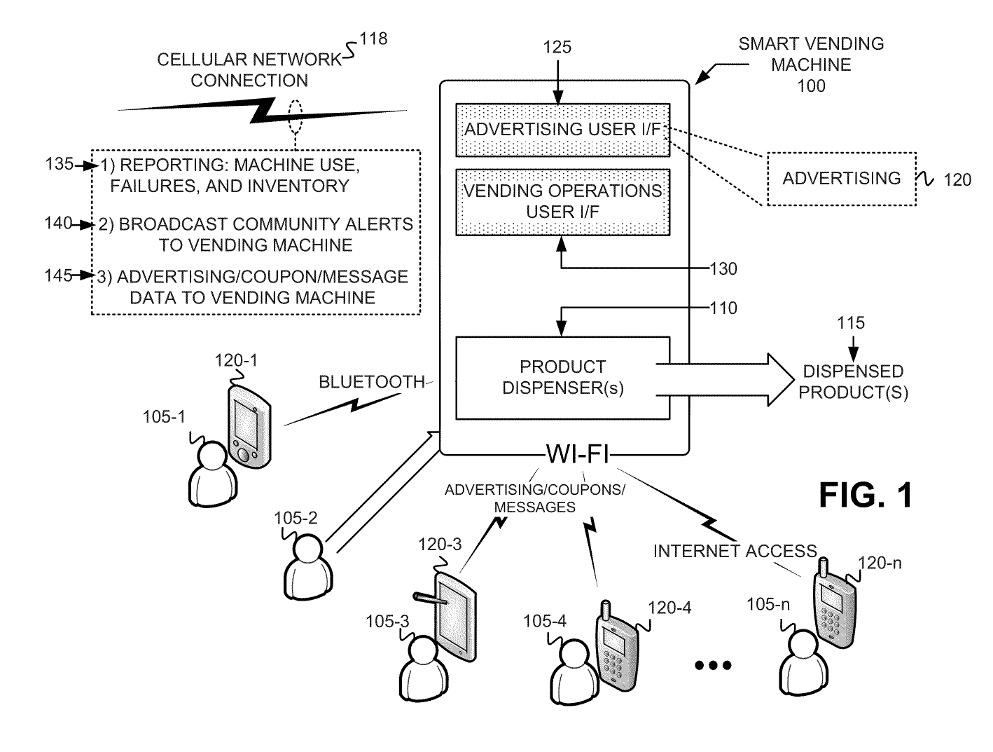

FIG. 1 illustrates an overview of a smart vending machine 100 according to exemplary embodiments described herein. Smart vending machine 100, in addition to dispensing products, has a variety of capabilities that include, for example, a cellular network connection for network communications, and a wireless local area network (LAN) router (e.g., Wi-Fi connection) for providing connections between wireless user devices and the Internet (e.g., via the cellular network connection). The smart vending machine 100 may additionally include personal area network (PAN) connections (e.g., Bluetooth) for permitting short range communications between wireless user devices and machine 100. As shown in FIG. 1, multiple users 105-1 through 105-n (where n is an integer greater than 1, generically and individually referred to herein as “user 105, collectively referred to herein as “users 105”) may interact with machine 100 so as to cause a product dispenser(s) 110 to dispense products 115. Product dispenser(s) 110 may include one or more dispensers that dispense various products. For example, in one implementation, product dispenser(s) 110 may include a bottled or canned beverage dispenser and a water dispenser. As further shown, some of users 105-1 through 105-n may carry a respective one of mobile user devices 120-1 through 120-n.

Smart vending machine 100 includes a first user interface (I/F) 125 for presenting advertising to users 105 and a second user I/F 130 for performing vending operations to cause product dispenser(s) 110 to dispense products 115. User interfaces 125 and 130 may include a color digital display such as, for example, a Liquid Crystal Display (LCD), a cathode ray tube (CRT) display, an organic light-emitting diode (OLED) display, a surface-conduction electro-emitter display (SED), a field emission display (FED), a bistable display, or a plasma display. User interfaces 125 and 130, in addition to having a color digital display, may include a touch panel (e.g., a touch screen display) that functions as a user input interface. For example, in one implementation, the touch panel may include a near field-sensitive (e.g., capacitive), acoustically-sensitive (e.g., surface acoustic wave), photo-sensitive (e.g., infrared), and/or any other type of touch panel that allows a display to be used as an input device. In one implementation, the touch panel may include multiple touch-sensitive technologies. Generally, the touch panel may include any kind of technology that provides the ability to identify the occurrence of a touch upon the touch panel.

Users 105-1 through 105-n may provide input via vending operations user interface 130 to select products 115 to be dispensed by product dispenser(s) 110. Advertising user interface 125 may provide advertising 120 to users 105-1 through 105-n based, at least in part, upon a location of vending machine 100, in one embodiment, as described in further detail below. FIG. 1 depicts advertising user I/F 125 as being located above vending operations user I/F 130 on a face of smart vending machine 100. In other embodiments (not shown), however, advertising user I/F 125 may be located side-by-side with, and/or adjacent to, vending operations user I/F 130.

As further shown in FIG. 1, smart vending machine 100 may provide a network connection 118 to a cellular network (not shown). The cellular network may include any type of cellular network such as, for example, a fourth generation (4G) Long Term Evolution (LTE) cellular network. Cellular network connection 118 may be used for reporting 135 the use of machine 100, failures associated with machine 100, and product inventory of machine 100 to a remote server (not shown). Cellular network connection 118 may further be used for receiving 140 broadcasted community alerts at machine 100. The community alerts may include, for example, Amber alerts, weather alerts (e.g., tornado alerts, hurricane alerts), disaster alerts (e.g., earthquake alerts), or other alerts of interest to the community. Cellular network connection 118 may also be used for receiving advertising, coupons, and/or message data. The advertising may be received from a remote advertising system that targets ads and/or coupons to a user 105 currently using machine 100. The message data may be received from a remote server that sends messages destined for a user 105 currently using machine 100.

FIG. 1 further depicts local wireless connections that smart vending machine 100 may provide to users 105 via their respective user devices 120-1 through 120-n. Vending machine 100 may include a transceiver for providing personal area network (PAN) connections to PAN-enabled ones of user devices 120-1 through 120-n. In one implementation, vending machine 100 may include a Bluetooth transceiver for short range Bluetooth communication between user devices 120-1 through 120-n and vending machine 100. Vending machine 100 may further include another transceiver for providing wireless local area network (LAN) connections to user devices 120-1 through 120-n. In one implementation, the wireless LAN connections may be provided by a Wi-Fi enabled router that includes a Wi-Fi transceiver. The wireless LAN connections may be provided by vending machine either free or for payment as, for example, a “Wi-Fi hotspot.” The Wi-Fi enabled router may communicate using the Institute of Electrical and Electronics Engineers (IEEE) 802.11 standard. One or more of devices 120-1 through 120-n may use the wireless LAN connection and cellular network connection 118 for obtaining Internet access (e.g., web browsing, email). One or more of devices 120-1 through 120-n may further receive advertising, electronic coupons or messages via a PAN connection or a wireless LAN connection. The electronic coupons may relate to certain products or services for sale.

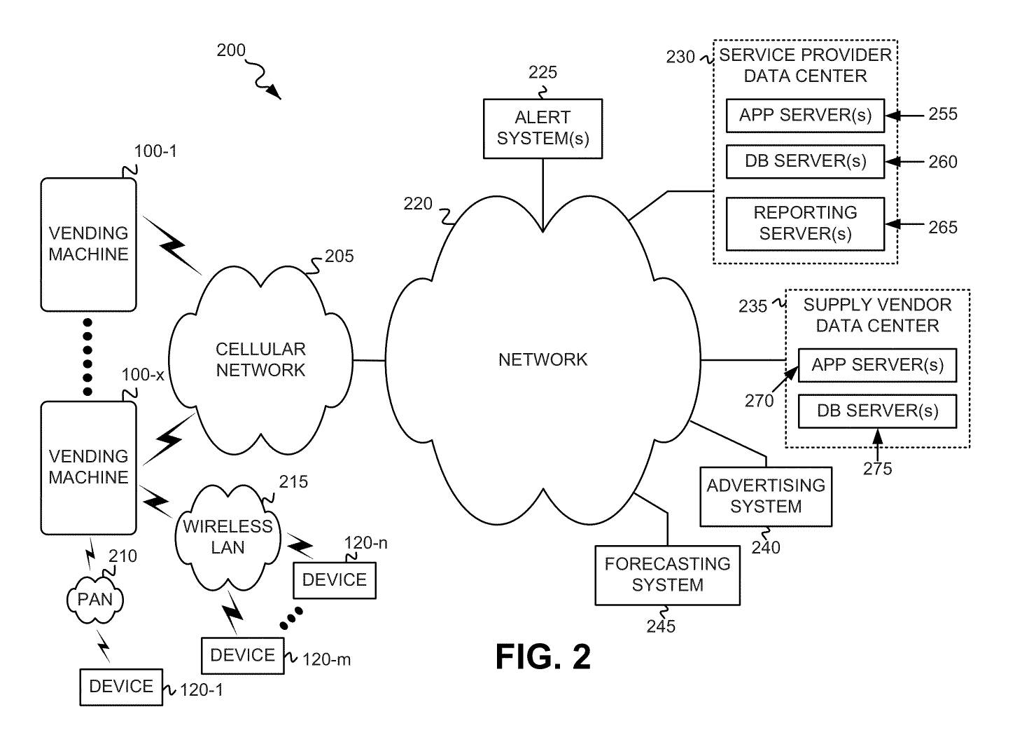

FIG. 2 depicts an exemplary network environment 200 in which multiple vending machines 100 may operate. Network environment 200 may include multiple vending machines 100-1 through 100-x (where x is an integer greater than or equal to one), a cellular network 205, at least one personal area network 210, a wireless local area network (LAN) 215, a network 220, an alert system(s) 225, a service provider data center 230, a supply vendor data center 235, an advertising system 240, a forecasting system 245, and user devices 120-1 through 120-n.

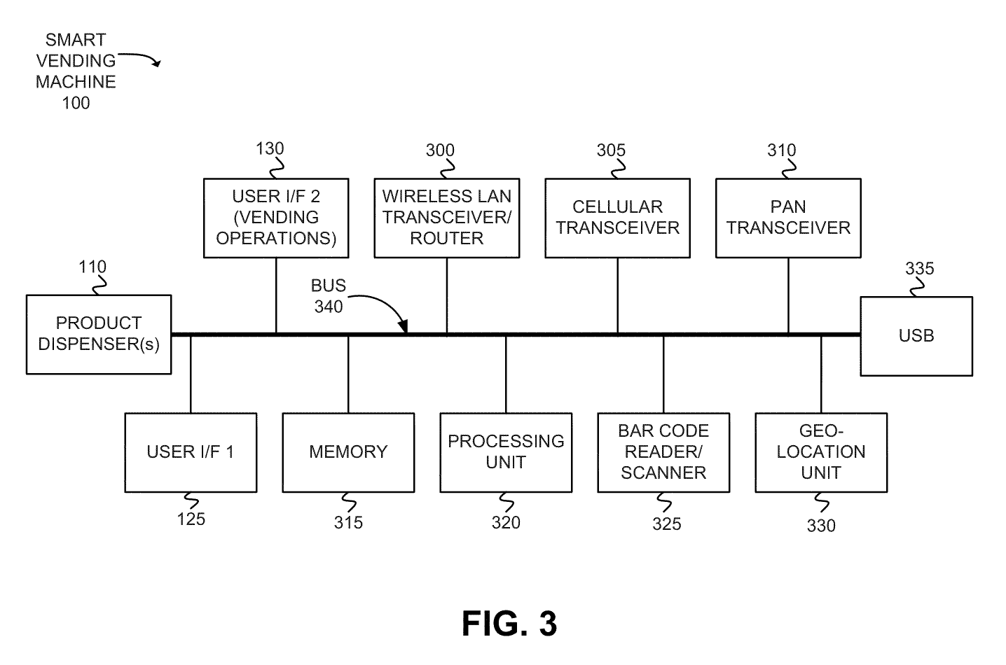

Vending machines 100-1 through 100-x (individually and generically referred to herein as “vending machine 100”) may dispense products and perform other functions as described with respect to FIG. 1 above, and FIGS. 3-13 below.

Cellular network 205 may include a wireless public land mobile network (PLMN) such as, for example, a Code Division Multiple Access (CDMA) 2000 PLMN, a Global System for Mobile Communications (GSM) PLMN, a Long Term Evolution (LTE) PLMN (e.g., Fourth Generation (4G) LTE) and/or other types of PLMNs.

Personal area network (PAN) 210 may include a short range wireless connection between a user device 120 and vending machine 100. In one embodiment, PAN 210 may include a Bluetooth connection between user device 120 and vending machine 100. Wireless LAN 215 may include, for example, a Wi-Fi LAN the permits multiple wireless connections with vending machine 100 based on the Institute of Electrical and Electronics Engineers (IEEE) 802.11 standard.

Network 220 may include one or more networks including, for example, a wireless public land mobile network (PLMN) (e.g., a Code Division Multiple Access (CDMA) 2000 PLMN, a Global System for Mobile Communications (GSM) PLMN, a Long Term Evolution (LTE) PLMN and/or other types of PLMNs), a telecommunications network (e.g., Public Switched Telephone Networks (PSTNs)), a local area network (LAN), a wide area network (WAN), a metropolitan area network (MAN), an intranet, the Internet, or a cable network (e.g., an optical cable network). Network 220 may enable vending machines 100-1 through 100-x and the various network devices of FIG. 2 to communicate with another.

Alert system(s) 225 may include one or more network devices associated with state, local or federal organizations that provide alerts for issues of wide importance. For example, alert system(s) 225 may be associated with state, local or federal disaster/emergency organizations that generate alerts based on the occurrence of a number of different events such as, for example, Amber alerts, weather alerts (e.g., tornado alerts, hurricane alerts), disaster alerts (e.g., earthquake alerts), or other alerts of interest to the community.

Service provider data center 230 may include various network devices such as, for example, one or more application (app) servers 255, one or more database (DB) servers 260, and one or more reporting server(s) 265. App server(s) 255 may execute applications used in analyzing data received from vending machines 100-1 through 100-x. DB server(s) 260 may store data received from vending machines 100-1 through 100-x for future retrieval and analysis. DB server(s) 260 may additionally store user profiles associated with users 105. Reporting server(s) 265 may receive various types of reports (described further below) and may store the reports in DB server(s) 260.

Supply vendor data center 235 may include various network devices such as, for example, one or more app servers 270 and one or more DB server(s) 275. App server(s) 270 may execute applications used in analyzing received inventory and product ordering data associated with vending machines 100-1 through 100-x. DB server(s) 275 may store the received inventory and product ordering data associated with vending machines 100-1 through 100-x.

Advertising system 240 may include a network device that generates advertisements, as described further below, for supply to users at vending machines 100-1 through 100-x. Forecasting system 245 may include a network device that generates product inventory forecasts, vending machine malfunction/outage forecasts, and vending machine usage forecasts based on reports received from vending machines 100-1 through 100-x. The forecasts generated by forecasting system 245 may be used to more efficiently schedule product replenishment at vending machines 100-1 through 100-x and to schedule planned maintenance of vending machines 100-1 through 100-x to avoid malfunctions or outages. Forecasting system 245 may build forecasting models based on tracking data received from smart vending machines 100. Forecasting system 245 may use the forecasting models for generating inventory forecasts, vending machine malfunction/outage forecasts, and vending machine usage forecasts. Such forecasts may be on an hourly, daily, weekly, or monthly basis. The forecasts may be on a per-machine basis, or a per-region basis (e.g., per city, per building, per campus, etc.), or may be aggregated across all reporting smart vending machines 100, or across some designated segment(s) of all reporting smart vending machines 100. The forecasts may be used, for example, for “just in time” product ordering and replenishment for specific smart vending machines 100, for scheduling maintenance to minimize machine malfunctions/outages of smart vending machines 100, for forecasting sales of products at smart vending machines 100.

User devices 120-1 through 120-n (individually and generically referred to herein as “user device 120”) may include any type of computing device that has wireless communication capabilities. User devices 120-1 through 120-n may each include, for example, a telephone (e.g., a smart phone), a computer (e.g., laptop, palmtop, desktop, or tablet computer), a set-top box (STB), a gaming device, or a personal digital assistant (PDA). User devices 120-1 through 120-n may connect with a vending machine 100 via PAN 210 and/or wireless LAN 215.

The configuration of network components of network environment 200 shown in FIG. 2 is for illustrative purposes. Other configurations may be implemented. Therefore, network environment 200 may include additional, fewer and/or different components, that may be configured in a different arrangement, than that depicted in FIG. 2. The various network devices of FIG. 2 have been described as performing certain functions. However, any network device in FIG. 2 can perform the functions described as being performed by other devices. Additionally, every device shown in FIG. 2 may communicate with every other device.

FIG. 3 is a diagram that depicts exemplary components of smart vending machine 100. Smart vending machine 100 may include user interface 125, user interface 130, a wireless LAN transceiver/router 300, a cellular transceiver/router 305, a PAN transceiver 310, a memory 315, a processing unit 320, a bar code reader/scanner 325, a geo-location unit 330, product dispenser(s) 110, a Universal Serial Bus (USB) port 335, and a bus 340.

Wireless LAN transceiver/router 300 may include a transceiver that may communicate, for example, according to a wireless standard and which may route data from user devices 120-1 through 120-n to network 220 (e.g., through cellular network 205), or from network 220 to user devices 120-1 through 120-n via cellular network 205 and wireless LAN 215. Wireless LAN transceiver/router 300 may include, for example, a Wi-Fi router. Cellular transceiver 305 may include a transceiver that has the capability to communicate via cellular network 205. PAN transceiver 310 may include a transceiver that communicates with user devices 120-1 through 120-n via short range wireless connections such as, for example, Bluetooth connections or Near Field Communications (NFC) connections. In some implementations, smart vending machine 100 may connect to network 220 and/or to one or more of user devices 120 via a wired connection.

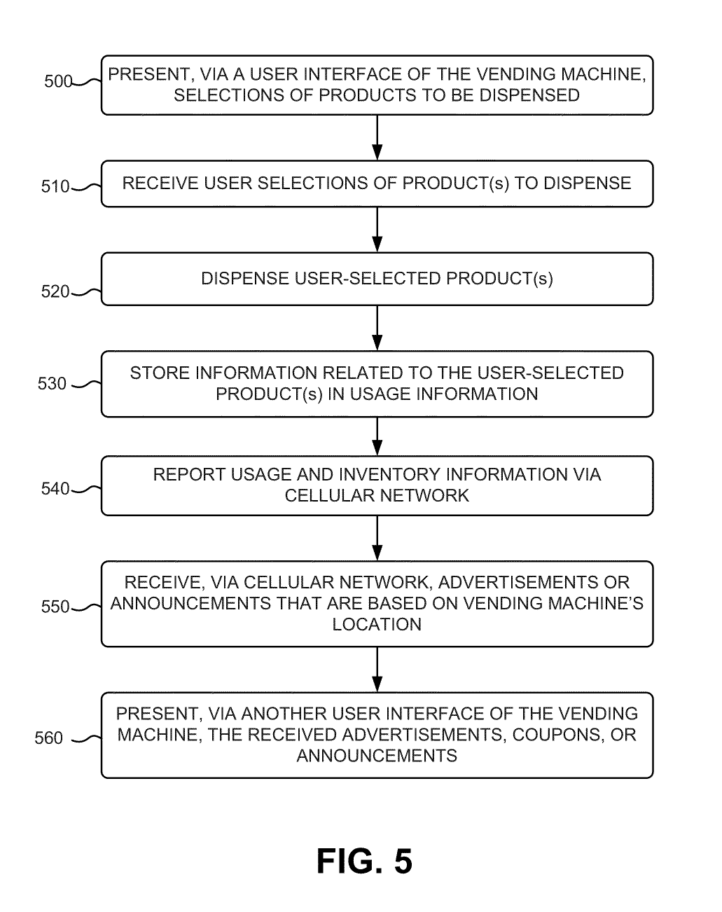

Memory 315 may include one or more different types of memory for storing data. Memory 315 may include a random access memory (RAM) or another type of dynamic storage device that may store information and instructions for execution by processing unit 320. Memory 315 may further include a Read Only Memory (ROM) device or another type of static storage device that may store static information and instructions for use by processing unit 320. Memory 315 may also include a magnetic and/or optical storage medium. Memory 315 may be referred to herein as a “non-transitory computer-readable medium.” Processing unit 320 may include one or more processors or microprocessors, or processing logic, which may interpret and execute instructions for performing, for example, the exemplary processes of FIGS. 5, 7, 9, and 11 below. Bar code reader/scanner 325 may include a camera, or other type of bar code reading device, that can read/scan bar codes. Geo-location unit 330 may determine a geo-location of smart vending machine 100. In one implementation, geo-location unit 330 may include a Global Positioning System (GPS) device. USB port 335 may include a port to which an external device(s) may be connected for local diagnostics/administration, or for other purposes. A service technician may, for example, connect a diagnostic device to USB port 335 to run diagnostic tests upon smart vending machine 100. Bus 340 may include a path that permits communication among the components of smart vending machine 100.

The configuration of components of smart vending machine 100 illustrated in FIG. 3 is for illustrative purposes. Other configurations may be implemented. Therefore, smart vending machine 100 may include additional, fewer and/or different components than those depicted in FIG. 3. The various components of smart vending machine 100 of FIG. 3 have been described as performing certain operations or functions. However, any component of machine 100 in FIG. 3 may be capable of performing the operations or functions described as being performed by other components of machine 100.

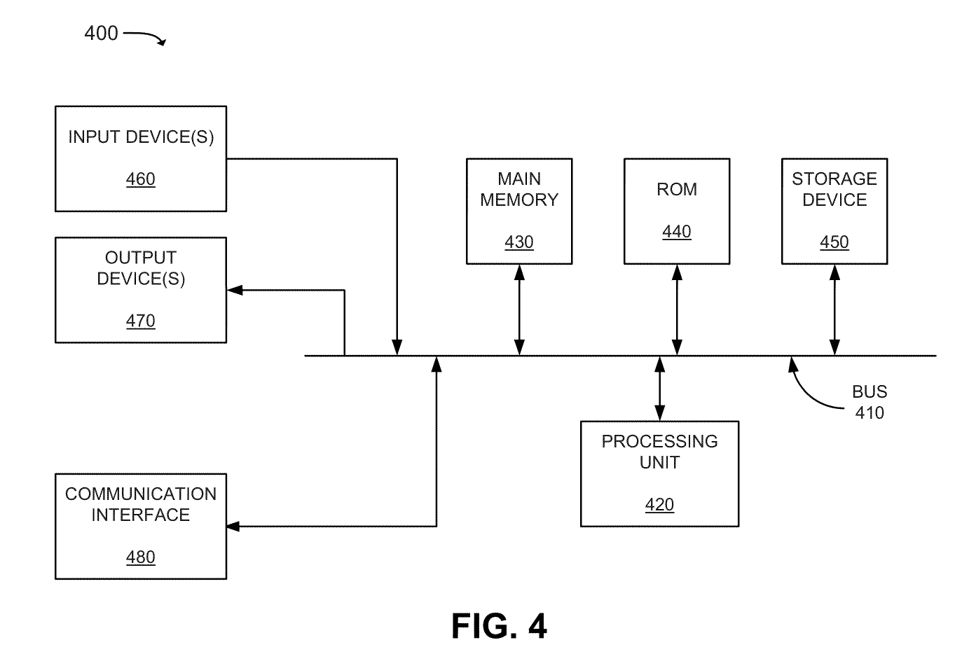

FIG. 4 is a diagram that depicts exemplary components of a network device 400. Network device 400 may correspond to device 120, alert system(s) 225, app server(s) 255, DB server(s) 260, reporting server(s) 265, app server(s) 270, DB server(s) 275, advertising system 240, forecasting system 245 or support system(s) 250.

Network device 400 may include a bus 410, a processing unit 420, a main memory 430, a read only memory (ROM) 440, a storage device 450, an input device(s) 460, an output device(s) 470, and a communication interface(s) 480. Bus 410 may include a path that permits communication among the components of network device 400.

Processing unit 420 may include one or more processors or microprocessors, or processing logic, which may interpret and execute instructions. Main memory 430 may include a random access memory (RAM) or another type of dynamic storage device that may store information and instructions for execution by processing unit 420. ROM 440 may include a ROM device or another type of static storage device that may store static information and instructions for use by processing unit 420. Storage device 450 may include a magnetic and/or optical recording medium. Main memory 430, ROM 440 and storage device 450 may each be referred to herein as a “non-transitory computer-readable medium.”

Input device 460 may include one or more mechanisms that permit an operator to input information to network device 400, such as, for example, a keypad or a keyboard, a display with a touch sensitive panel, voice recognition and/or biometric mechanisms, etc. Output device 470 may include one or more mechanisms that output information to the operator, including a display, a speaker, etc. Input device 460 and output device 470 may, in some implementations, be implemented as a user interface that displays user interface information and which receives user input via the user interface. Communication interface(s) 480 may include a transceiver that enables network device 400 to communicate with other devices and/or systems. For example, communication interface(s) 480 may include wired or wireless transceivers for communicating via network 220, wireless LAN 215 or PAN 210.

The configuration of components of network device 400 illustrated in FIG. 4 is for illustrative purposes. Other configurations may be implemented. Therefore, network device 400 may include additional, fewer and/or different components than those depicted in FIG. 4.

The various components of network device 400 of FIG. 4 have been described as performing certain operations or functions. However, any component of network device 400 in FIG. 4 may be capable of performing the operations or functions described as being performed by other components of network device 400.

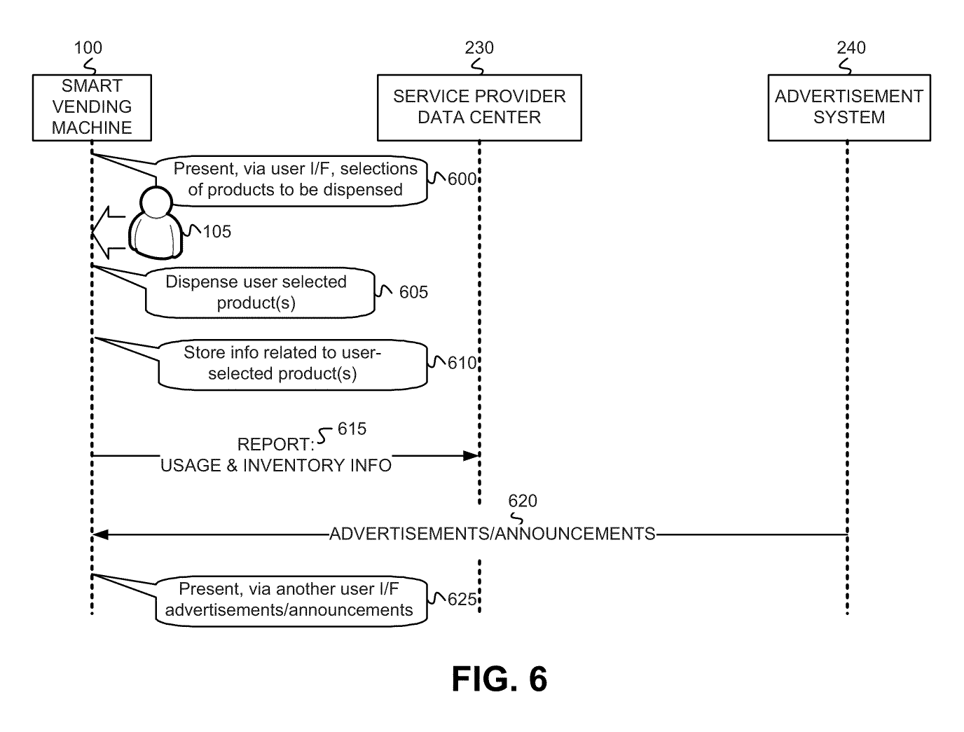

FIG. 5 is a flow diagram of an exemplary process for dispensing users-selected products at smart vending machine and for presenting advertisements to the user. The exemplary process of FIG. 5 may be implemented by smart vending machine 100. The description of the exemplary process of FIG. 5 below refers to the exemplary messaging diagram of FIG. 6.

The exemplary process may include smart vending machine 100 presenting, via user interface 130, selections of products to be dispensed (block 500). In an implementation in which user interface 130 includes a touch screen display, the touch screen display may present a list of products available to dispense from smart vending machine 100, and user 105 may select one or more products by touching the listed product on the touch screen display. FIG. 6 depicts smart vending machine 100 presenting 600, via the user I/F, selections of products to be dispensed to user 105.

Smart vending machine 100 receives the user selections of the product(s) to dispense (block 510) and dispenses the user-selected product(s) (block 520). In the implementation in which user interface 130 includes the touch screen display, user 105 may touch a selected product(s) on the touch screen display, and smart vending machine 100 may dispense the selected product(s) via product dispenser(s) 110. Prior to dispensing the selected products, user 105 may provide an appropriate payment to vending machine 100 that covers the cost of the product(s) to be dispensed. FIG. 6 depicts smart vending machine 100 dispensing 605 the product(s) selected by user 105 via the user I/F.

Smart vending machine 100 stores information related to the user-selected product(s) in usage information (block 530) and reports the usage and inventory information via, for example, cellular network 205 (block 540). Smart vending machine 100 may accumulate and store usage information for each user 105 for a period of time prior to, or even subsequent to, reporting the usage to service provider data center 230. Vending machine 100 may identify user 105 based on, for example, manual identification by user 105, or based on a network address (e.g., a MAC address) associated with user 105's user device 120. Smart Vending machine 100 may additionally track the current product inventory based on each user 105's usage of machine 100. FIG. 6 depicts smart vending machine 100 storing 610 information related to the user-selected products, and sending a report 615 that reports machine 100's current product usage and inventory. In some embodiments, the reporting of the usage and inventory information may additionally include sending an order to supply vendor data center 235 ordering a product(s) determined to be out of stock, or low on stock.

Smart vending machine 100 receives, via cellular network 205, advertisements, coupons, and/or announcements that are based on vending machine 100's location (block 550) and may present the received advertisements and/or announcements via user interface 125 (block 560). Advertisement system 240 may target advertisements and/or coupons to smart vending machine 100 based solely on machine 100's known location, or based on an identity of a user 105 currently using machine 100. The identity of user 105 may be determined by smart vending machine 100 via user 105 manually entering their identity via user interface 125 or 130, via a manually or automatically generated electronic message sent via PAN network 210 (e.g., via Bluetooth), via a manually or automatically generated message sent via wireless LAN 215, via recognition of a network address (e.g., a MAC address) associated with user 105's user device 120, or via facial recognition applied to user 105's face. Advertisement system 240 may use various different targeting techniques for targeting ads or coupons to smart vending machine 100 or to user 105 that is using machine 100. For example, advertisements or coupons may be targeted to machine 100 based on the location of machine 100 in close proximity to other businesses. FIG. 6 depicts advertisement system 240 sending advertisements or announcements 620 to smart vending machine 100. The announcements may include broadcast community alerts such as, for example, Amber alerts, weather alerts (e.g., tornado alerts, hurricane alerts), disaster alerts (e.g., earthquake alerts), or other alerts of interest to the community generally, or specifically to the location of vending machine 100 (e.g., a tornado sighting in close proximity to a location of vending machine 100). Advertisement system 240, or another network device, may receive community alerts from, for example, alert system(s) 225 associated with state, local or federal disaster/emergency organizations (e.g., state, local or federal Emergency Operations Centers (EOCs)) via, for example, the Commercial Mobile Alert Service (CMAS). The alerts may be sent to vending machine from an EOC via an alert gateway, network 220, and cellular network 205. The announcements may include text, video or audio.

Additionally, the advertisements, announcements or coupons may be presented to user 105 at user device 120 via cellular network 205. For example, vending machine 100 may obtain the telephone number associated with user 105's user device 120 (e.g., via manual entry by user 105, or via automatic retrieval from user device 120 via PAN 210 or wireless LAN 215). Vending machine 100 may supply the telephone number to advertising system 240 which may then send ads, announcements or coupons to user device 120 via cellular network 205 (e.g., via SMS messages).

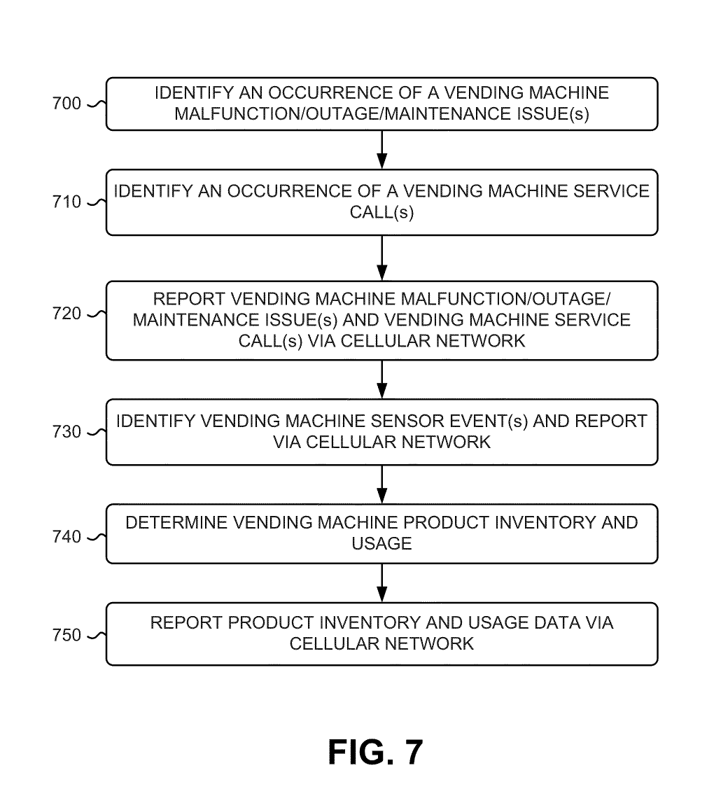

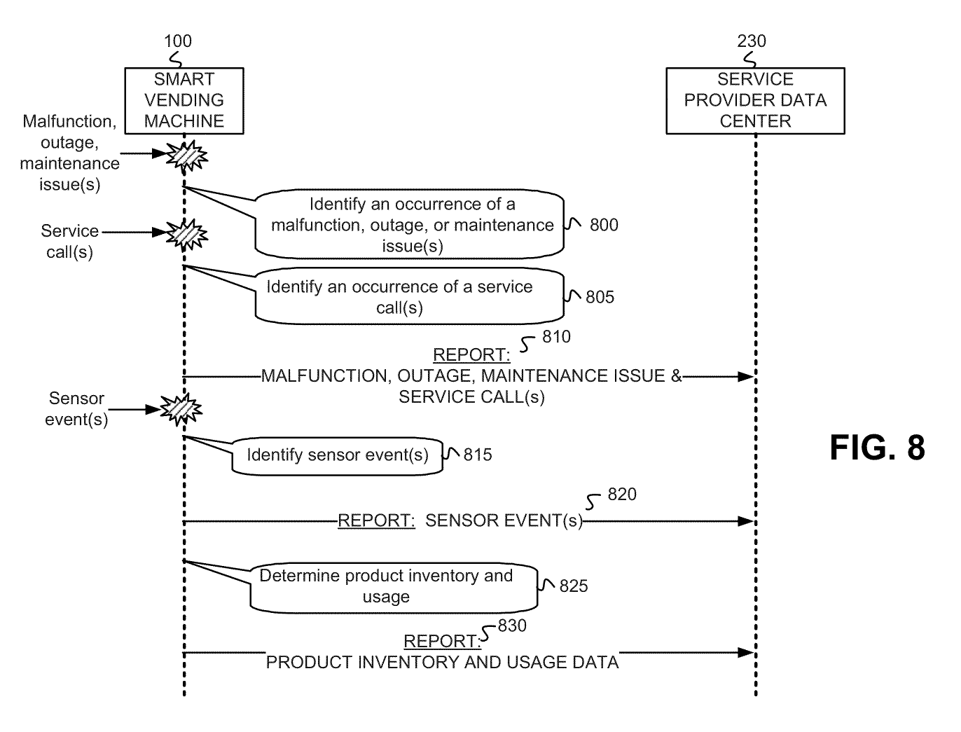

FIG. 7 is a flow diagram of an exemplary process for reporting the various maintenance related issues, sensor events, and product inventory and usage associated with smart vending machine 100. The exemplary process of FIG. 7 may be implemented by smart vending machine 100. The description of the exemplary process of FIG. 7 below refers to exemplary messaging diagram of FIG. 8.

The exemplary process may include smart vending machine 100 identifying an occurrence of a vending machine malfunction, outage or maintenance issue(s) (block 700). Many different machine malfunctions, outages, or maintenance conditions may arise during the operation of machine 100. Smart vending machine 100 may maintain an internal log of all of the various different malfunctions, outages or maintenance conditions that occur. FIG. 8 depicts the occurrence of a malfunction, outage or maintenance condition, and the identification 800 of the malfunction, outage, or maintenance condition by machine 100.

Smart vending machine 100 may identify an occurrence of a vending machine service call(s) (block 710). A servicing professional, when servicing machine 100 for general maintenance, or to fix a malfunction or outage, may manually enter the service call in machine 100. Alternatively, the servicing professional may connect to machine 100 via a device (e.g., via Bluetooth or Wi-Fi), and the device may automatically generate a record in machine 100 that includes details of the service call, and the maintenance or repair performed by the servicing professional. Additionally, in the event that servicing is performed from a remote device, the remote device may generate a record in machine 100 that includes details of the service call. FIG. 8 depicts the occurrence of a service call(s) and the identification 805 of the occurrence of the service call(s) by machine 100.

Smart vending machine 100 may report any vending machine malfunction, outage or maintenance issue(s) and any vending machine service calls via cellular network 205 (block 720). Smart vending machine 100 may report the vending machine malfunction, outage or maintenance issue(s), or the service call(s), to a reporting server(s) 265 of service provider data center 230. FIG. 8 depicts smart vending machine 100 sending a report 810, which reports the occurrence of malfunctions, outages, maintenance issues or service calls at machine 100, to service provider data center 230.

Smart vending machine 100 may identify a vending machine sensor event(s) and report the event(s) via cellular network 205 (block 730). Smart vending machine 100 may include various types of sensors that detect certain conditions within, or within the vicinity of, machine 100. For example, smart vending machine 100 may include a temperature sensor, and may identify an instance when the detected temperature rises above a configurable value. As another example, smart vending machine 100 may include an accelerometer that detects when machine 100 undergoes violent motion such as, for example, an earthquake, falling over, or being impacted with an object during an attempt to steal internally stored products or cash. FIG. 6 depicts smart vending machine 100 identifying 815 the occurrence of a sensor event(s), and sending a report 820 to service provider data center 230 that details the sensor event(s). Reporting server (s) 265 of service provider data center 230 may store the sensor event(s) in DB server(s) 260 for analysis.

Smart vending machine 100 may determine the vending machine 100's product inventory and usage (block 740), and report product inventory and usage data via cellular network 205 (block 750). Smart vending machine 100 may track all purchases by users, and maintain a running tally of the current inventories of the different products dispensed by machine 100. Smart vending machine 100 may, therefore, maintain data on current usage rates of each product currently in inventory. FIG. 6 depicts smart vending machine 100 determining 825 product inventory and usage, and sending a report 830 to service provider data center 230 that includes product inventory and usage data. Reporting server(s) 265 of service provider data center 230 may store the product inventory and usage data in DB server(s) 260 for analysis. Service provider data center 230 may, based on an analysis of the product inventory and usage data stored in DB server(s) 260, send a product order(s) to supply app server(s) 270 of vendor data center 235 such that appropriate quantifies of ordered products are obtained and scheduled for replenishing the inventory at smart vending machine 100.

The exemplary process of FIG. 7 may be repeated on a continuous basis during the operation of smart vending machine 100. In some implementations, blocks 700, 710, 730 and 740 may be performed continuously during the operation of smart vending machine 100, whereas blocks 720 and 750 may be performed at periodic intervals, with each report including accumulated data regarding multiple occurrences of blocks 700, 710, 730 and 740.

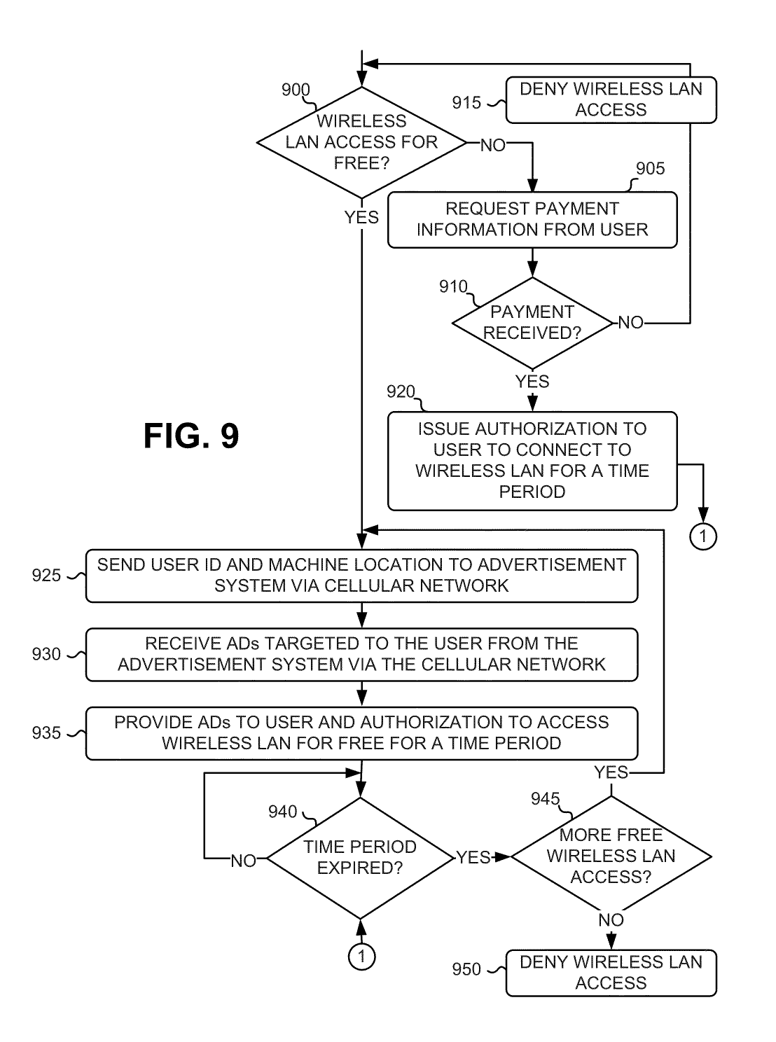

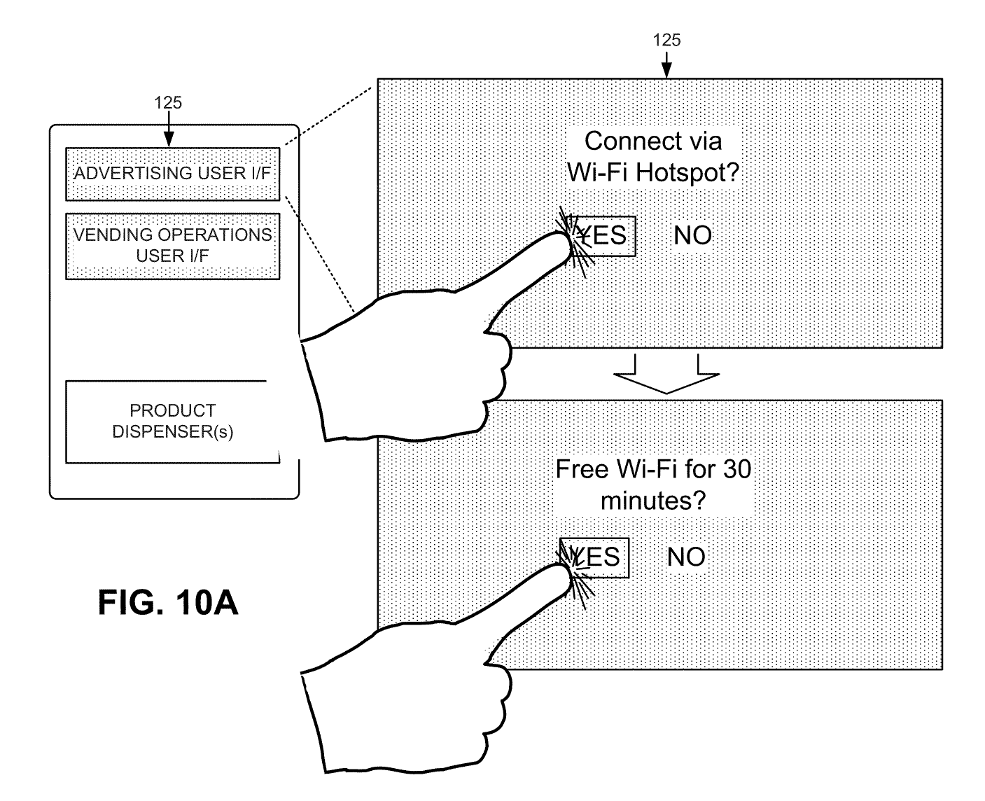

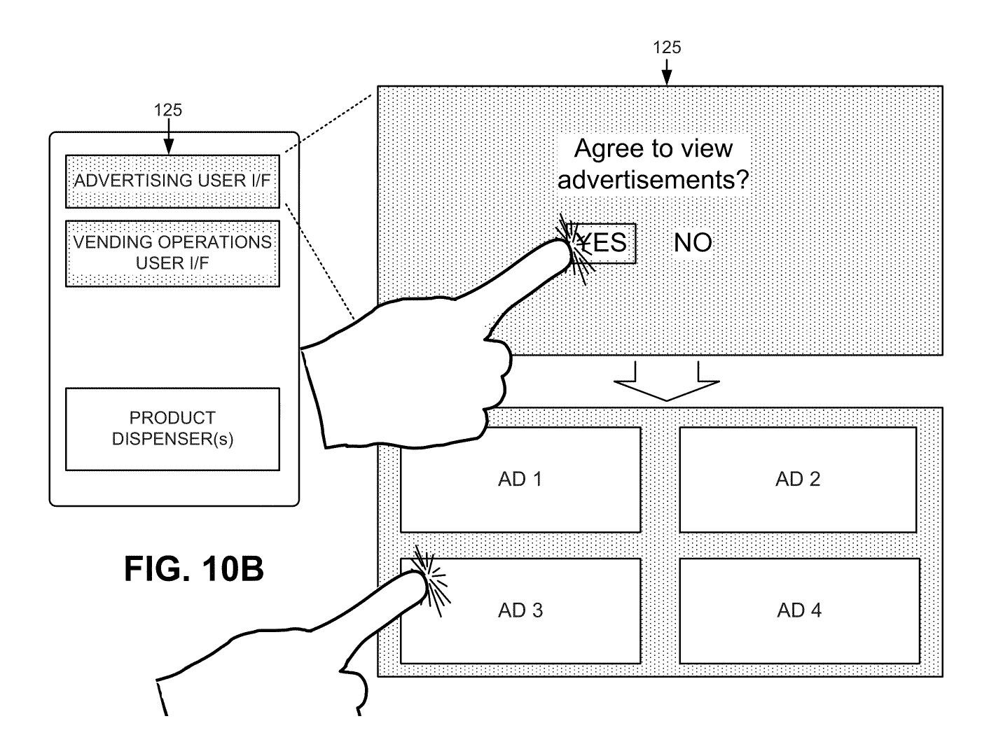

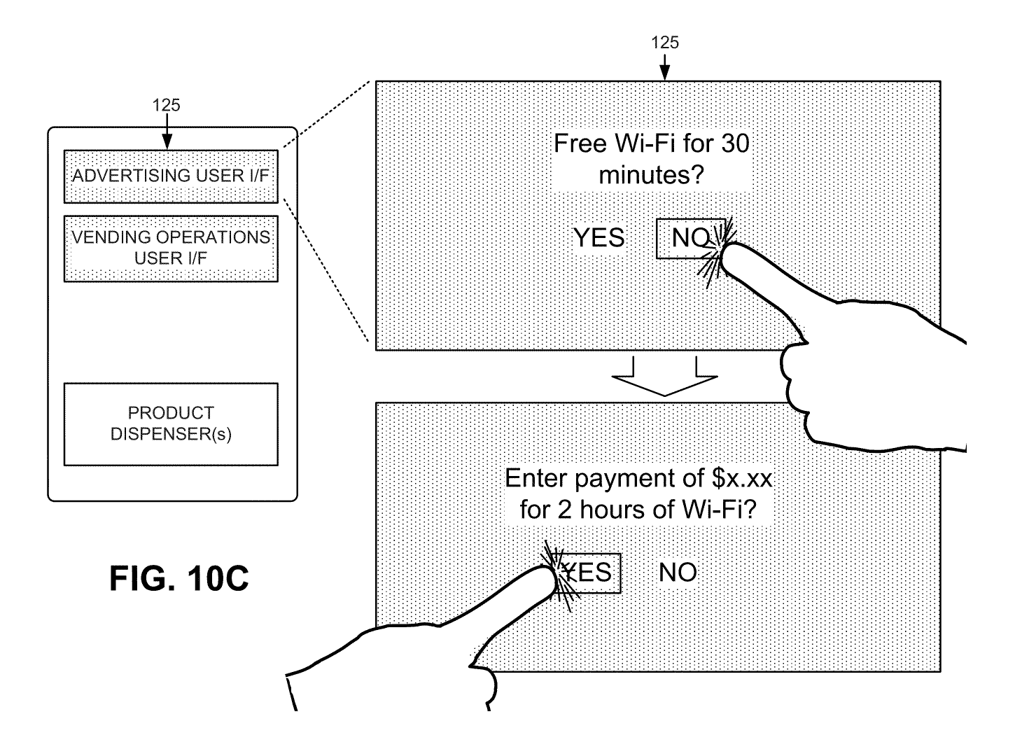

FIG. 9 is a flow diagram of an exemplary process for providing wireless LAN access to one or more of devices 120-1 through 120-n associated with respective users 105-1 through 105-n. The exemplary process of FIG. 9 may be performed by smart vending machine 100. The description of the exemplary process of FIG. 9 below refers to the examples of FIGS. 10A-10C.

The exemplary process may include smart vending machine 100 determining if user 105 wishes to have wireless LAN access for free (block 900). Smart vending machine 100 may offer wireless LAN access (e.g., Wi-Fi access) either for free, with conditions, or for a fee for a specified period of time to user device 120. The conditions associated with receiving free wireless LAN access may include user 105 agreeing to view one or more advertisements prior to being granted wireless LAN access for a certain period of time (e.g., 15 minutes). To determine whether user 105 wishes to receive free wireless LAN access in the vicinity of smart vending machine 100, machine 100 may ask via user interfaces 125 or 130. For example, in an implementation in which user interface 125 includes a touch screen display, touch screen display 125 may first request whether user 105 wishes to “connect via Wi-Fi hotspot?” with the option of selecting “Yes” or “No.” If user 105 touches “Yes” on touch screen display 125, then vending machine 100 may request whether user 105 wishes to have access to “Free Wi-Fi for 30 minutes?” with the option of selecting “Yes” or “No.” If user 105 touches “Yes” on touch screen display 125, then vending machine 100 permits user 105 at device 120 to connect to wireless LAN 215 for free for 30 minutes.

If user 105 at user device 120 indicates that they wish to receive access to wireless LAN 215 for free (YES—block 900), then smart vending machine 100 may send a user ID associated with user 105 and a location of machine 100 to advertisement system 240 via cellular network 205 (block 925). The identity of user 105 may be determined by smart vending machine 100 via user 105 manually entering their identity via user interface 125 or 130, via a manually or automatically generated electronic message sent via PAN network 210 from user device 120 (e.g., via Bluetooth), or via a manually or automatically generated message sent via wireless LAN 215 from user device 120. FIG. 10B depicts vending machine 100 requesting whether user 105 will “agree to view advertisements” with the option of selecting “Yes” or “No.”

Smart vending machine 100 may receive advertisements (Ads) targeted to the user from advertisement system 240 via cellular network 205 (block 930). Advertisement system 240 may use various different advertisement targeting techniques for targeting ads to smart vending machine 100 to user 105. For example, advertisements may be targeted to user 105 based on a profile of past vending machine usage of user 105 stored at DB server(s) 260. Advertisement system 240 may target ads to user 105 based on other factors. Smart vending machine 100 may provide the ads to user 105 at user device 120 and an authorization (e.g., a pass code or key) to access wireless LAN 215 for free for a time period (block 935). As further shown in FIG. 10B, if user 105 selects “Yes” in response to the inquiry whether user 105 agrees to view advertisements, multiple ads AD1, AD2, AD3 and AD4 may be displayed to user 105 via touch screen display 125. User 105 may view further details of ads AD1, AD2, AD3 and/or AD4 by touching one or more of the ads. Each of multiple ads AD1, AD2, AD3 and AD4 may include a device specific authentication embedded in a Uniform Resource Locator (URL) so that when the ad is retrieved, selected (e.g., clicked on), or utilized by user 105, it can be identified exactly which vending machine 100 (or user device 120) from which the ad was displayed. An analysis may be performed to identify types or categories of advertisements, or even specific advertisements, that were most or least successful for each vending machine 100 and for specific geographic areas. In a further embodiment, each ad displayed at vending machine 100 may include a bar code that may be scanned by user 105's user device 120 to cause user device 120 to access a particular ad or to access a particular coupon, offer or related advertisements.

Smart vending machine 100 may determine if the time period has expired (block 940). The time period includes the configurable period permitted for the user to have free wireless LAN access before having to view additional advertisements. If the time period has expired (YES—block 945), then smart vending machine 100 may determine if user 105 wishes to continue receiving free access to wireless LAN 215 (block 945). Referring to FIG. 10B, vending machine 100 may again present the inquiry “Agree to view advertisements” with the options “Yes” or “No” to user 105 via touch screen display 125. If user 105 wishes to continue receiving free access to wireless LAN 215 (YES—block 945), then the exemplary process may return to block 925 with smart vending machine 100 again sending the user's ID and the machine location to advertisement system 240. If user 105 at user device 120 does not wish to continue receiving free access to wireless LAN 215 (NO—block 945), then smart vending machine 100 may deny wireless LAN access to user 105 at user device 120 (block 950). Alternatively, if user 105 at user device 120 does not wish to continue receiving free access to wireless LAN 215 (NO—block 945), then the exemplary process may continue from block 945 to block 905.

Returning to block 900, if user 105 at user device 120 indicates that he/she does not wish to receive free access to wireless LAN 215 (NO—block 900), then smart vending machine 100 may request payment information from user 105 for user to access wireless LAN 215 (block 905). If payment is received (YES—block 910), then smart vending machine 100 may issue authorization to user 105 to connect to wireless LAN 215 for a time period (block 920). The exemplary process may continue at block 940. If no payment is received from user 105 (NO—block 910), then smart vending machine 100 may deny wireless LAN access to user 105 at user device 120 (block 915). As shown in FIG. 10C, vending machine 100 may present the inquiry “Free Wi-Fi for 30 minutes” with the options of responding with “Yes” or “No” via touch screen display 125. If, as shown in FIG. 10C, user 105 touches “No,” then vending machine 100 may present the inquiry “Enter payment of $x.xx for 2 hours of Wi-Fi?” with the options of responding with “Yes” or “No” via touch screen display 125. If, as shown in FIG. 10C user 105 touches “Yes,” then user 105 may proceed to enter the requirement payment. If user 105 touches “No,” then vending machine 100 may deny access to user 105 to wireless LAN 215.

The exemplary process of FIG. 9 may be repeated for each user 105 that seeks to access smart vending machine 100's wireless LAN 215. In alternative embodiments, the inquiries presented to user 105, as shown in FIGS. 10A-10C, may be presented to user 105's device 120 via PAN 210 (e.g., via Bluetooth) or via wireless LAN 215 (e.g., via a temporary Wi-Fi connection).

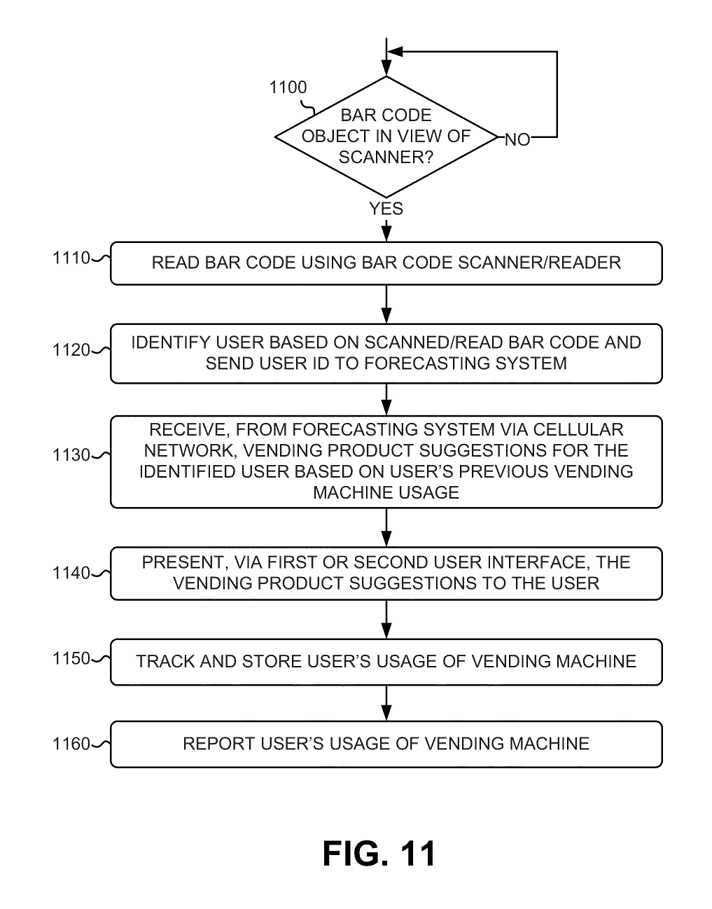

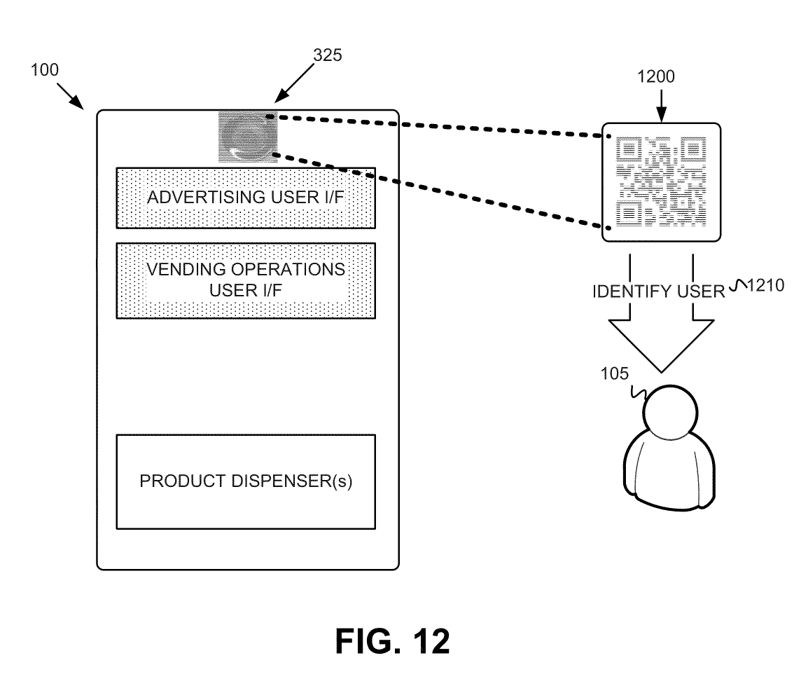

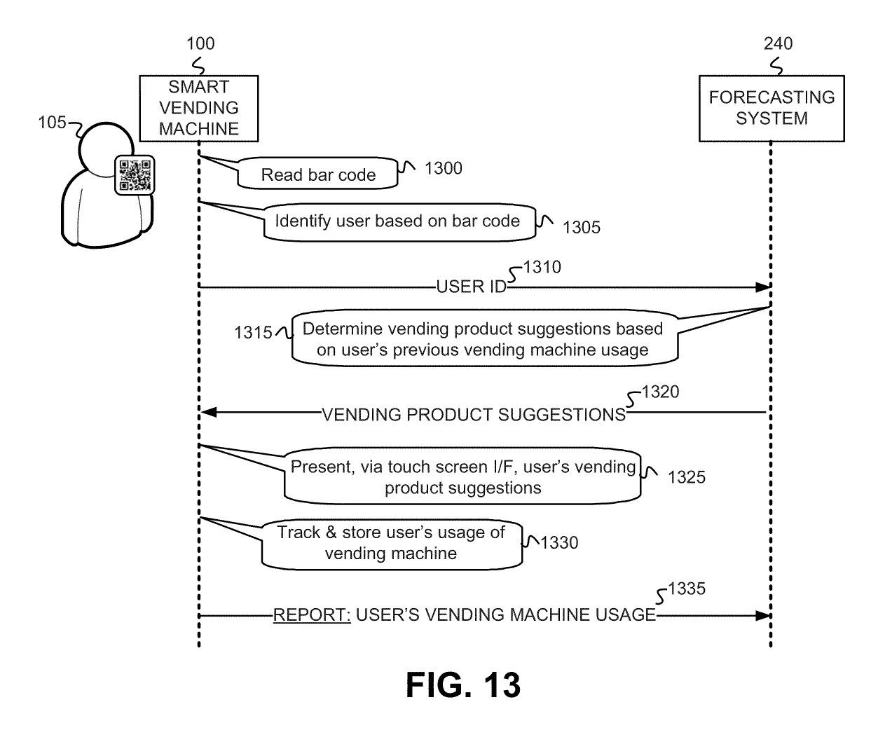

FIG. 11 is a flow diagram of an exemplary process for receiving product suggestions for a user 105 using vending machine 100 based on the scanning/reading of a bar code associated with user 105. The exemplary process of FIG. 11 may be performed by smart vending machine 100. The description of the exemplary process of FIG. 11 below refers to the example of FIG. 12 and the exemplary messaging diagram of FIG. 13.

The exemplary process may include smart vending machine 100 determining if a bar code object is in view of bar code reader/scanner 325 (block 1100). For example, as shown in FIG. 12, user 105 may hold an object that includes a bar code 1200 in front of a bar code reader/scanner 325, and bar code reader/scanner 325 may detect the presence of the object that includes bar code 1200. Bar code 1200 may include any type of bar code such as, for example, a Quick Response (QR) matrix bar code. Bar code 1200 may be disposed on various objects including a card having bar code 1200 on its face, or on a display of user device 120 that user 105 holds in front of reader/scanner 325. If a bar code object is in view of bar code reader/scanner 325 (YES—block 1100), smart vending machine 100 may read/scan the bar code using bar code scanner/reader 325 (block 1110). FIGS. 12 and 13 depict bar code reader/scanner 325 reading 1300 bar code 1200 that user 105 has held in front of scanner/reader 325 of machine 100.

Smart vending machine 100 may identify user 105 based on the scanned/read bar code and may send a user identifier (ID) for user 105 to forecasting system 240 (block 1120). Smart vending machine 100, or DB server(s) 260, may maintain a table that associates a user identifier with a given bar code. Therefore, vending machine 100 may identify user 105 based on the scanned bar code, or vending machine 100 may send the scanned bar code values to DB server(s) 260 and may receive the user ID in response. FIG. 13 depicts smart vending machine 100 identifying 1305 user 105 based on the scan of the bar code, and sending a user ID 1310 to forecasting system 240.

Smart vending machine 100 may receive, from forecasting system 240 via cellular network 205, vending product suggestions for the identified user based on user 105's previous vending machine usage (block 1130). Forecasting system 240 may access user 105's previous vending machine usage stored at DB server(s) 265 (sent previously at block 540 during one or more occurrences of the exemplary process of FIG. 5, or at block 1150 below) to generate vending product suggestions. Forecasting system 240 may use any number of different forecasting algorithms for generating vending product suggestions based on user 105's previous vending machine usage stored at DB server(s) 265. FIG. 13 depicts forecasting system 250 sending vending product suggestions 1320 to smart vending machine 100.

Smart vending machine 100 may present, via user interface 125 or 130, the vending product suggestions to user 105 (block 1140). FIG. 13 depicts vending machine 110 presenting 1325, via a touch screen interface 125 or 130, user 105's vending product suggestions.

Smart vending machine 100 may track and store user 105's usage of vending machine 100 (block 1150) and may report user 105's usage of vending machine 100 (block 1160). As user 105 purchases different products from vending machine 100, machine 100 may track and store those purchases for reporting to service provider data center 230. FIG. 13 depicts smart vending machine 100 tracking and storing 1330 user 105's usage of vending machine 100, sending a report 1335 to forecasting system 240, or service provider data center 230 (not shown) that includes data detailing user 105's vending machine usage.

The exemplary process of FIG. 11 may be repeated for each bar code object placed in view of bar code reader/scanner 325.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 5, 7, 9 and 11, the order of the blocks may be varied in other implementations. Moreover, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

1. A vending machine, comprising:
a product dispensing unit;
a first transceiver configured to communicate via a network;
a first user interface disposed at a first location on a face of the vending machine and configured to permit users to engage in vending operations so as to cause the dispensing unit to dispense products from the vending machine; and
a second user interface disposed at a second location on the face of the vending machine and configured to display information received via the first transceiver.

2. The vending machine of claim 1, wherein the first transceiver comprises a first wireless transceiver and the network comprises a cellular network and wherein the first wireless transceiver is configured to communicate via the cellular network.

3. The vending machine of claim 2, further comprising:
a second wireless transceiver configured to communicate via a wireless local area network (LAN) with one or more mobile devices.

4. The vending machine of claim 3, wherein components of the vending machine are configured to:
route data received via the second wireless transceiver through the first wireless transceiver via the cellular network,
route data receive via over the cellular network via the first wireless transceiver through the second wireless transceiver to the one or more mobile devices via the wireless LAN.

5. The vending machine of claim 3, wherein the second wireless transceiver comprises a Wi-Fi transceiver that communicates based on the Institute of Electrical and Electronics Engineers (IEEE) 802.11 standard.

6. The vending machine of claim 5, wherein the second wireless transceiver further comprises a Wi-Fi enabled router.

7. The vending machine of claim 2, wherein the cellular network comprises a fourth generation (4G) Long Term Evolution (LTE) cellular network.

8. The vending machine of claim 1, wherein the first and second user interfaces each comprise separate touch screen displays.

9. The vending machine of claim 1, wherein the first user interface comprises a touch screen display.

10. The vending machine of claim 2, wherein the information received via the first wireless transceiver comprises an advertisement received from an advertising system over the cellular network.

11. The vending machine of claim 2, wherein the information received via the first wireless transceiver over the cellular network comprises electronic coupons related to products or services for sale.

12. The vending machine of claim 2, wherein the information received via the wireless transceiver over the cellular network comprises information related to community or emergency alerts.

13. The vending machine of claim 1, wherein the information comprises text, video or audio received over the network.

14. The vending machine of claim 3, further comprising:
a third wireless transceiver configured to communicate via personal area networks with multiple mobile devices.

15. The vending machine of claim 14, wherein the third wireless transceiver comprises a short range transceiver that communicates based on the Bluetooth standard.

16. A vending machine, comprising:
a product dispensing unit;
a wireless transceiver configured to communicate via a cellular network;
a Wi-Fi transceiver configured to communicate via a wireless local area network (LAN) with one or more mobile devices based on the Institute of Electrical and Electronics Engineers (IEEE) 802.11 standard;
a first touch screen display disposed at a first location on a face of the vending machine and configured to permit users to engage in vending operations so as to cause the dispensing unit to dispense products from the vending machine; and
a second touch screen display disposed at a second location on the face of the vending machine and configured to display advertising or announcements received via the wireless transceiver over the cellular network.

17. The vending machine of claim 16, wherein the vending machine permits Wi-Fi access to the one or more mobile devices via the Wi-Fi transceiver and the wireless transceiver.

18. The vending machine of claim 16, wherein the announcements comprise text, video or audio.

19. The vending machine of claim 16, further comprising:
a Bluetooth transceiver configured to communicate with the one or more mobile devices based on the Bluetooth standard.

20. The vending machine of claim 16, wherein the wireless transceiver comprises a fourth generation (4G) Long Term Evolution (LTE) transceiver.

21. The vending machine of claim 16, wherein the announcements relate to community of emergency alerts.

22. The vending machine of claim 16, wherein the Wi-Fi transceiver comprises a Wi-Fi enabled router.
